(19) United States
(12) Patent Application Publication
(10) Pub. No.: US 2023/0205594 A1
(43) Pub. Date: Jun. 29, 2023

(54) DYNAMIC RESOURCE ALLOCATION

(71) Applicant: Intel Corporation, Santa Clara, CA (US)

(72) Inventors: Akhilesh S. THYAGATURU, Tempe, AZ (US); Robert KAMP, Cumming, GA (US); Anil S. KESHAVAMURTHY, Portland, OR (US); Mohit Kumar GARG, Hisar (IN)

(21) Appl. No.: 18/116,694

(22) Filed: Mar. 2, 2023

Related U.S. Application Data
(60) Provisional application No. 63/324,289, filed on Mar. 28, 2022.

(51) Int. Cl. G06F 9/50; G06F 9/4401; G06F 9/455

(52) U.S. Cl. CPC G06F 9/5044; G06F 9/4403; G06F 9/45541

(57) ABSTRACT

Examples described herein relate to executing a first boot firmware code to receive an allocation of hardware devices and allocating, by the first boot firmware code, resource allocations to one or more secondary boot firmware codes. In some examples, the one or more secondary boot firmware codes allocate use of hardware devices to one or more operating systems (OSs).

### RELATED APPLICATION

This application claims priority to U.S. Provisional Application No. 63/324,289, filed Mar. 28, 2022. The entire contents of that application are incorporated by reference in its entirety.

### BACKGROUND

FIG. 1 depicts an example of dynamic platform resource assignments supporting multiple hypervisors and operating systems on a platform. In a computing system, a single or multiple basic input/output systems (BIOSs) can statically enumerate resources assigned to hypervisors and operating systems. In turn, a single operating system (OS) or hypervisor, instantiated over the BIOS, can statically allocate resource resources to guest virtual machines (VMs), containers, and applications. Smart edge computing can utilize a smart edge node OS (on the edge node) and a controller to allocate resources. However, in a smart edge computing environment, an OS and smart edge node OS may not coexist in bare-metal environments and the hardware platform can be partitioned to execute the OS and smart edge OS in different partitions as coordinated by multiple controllers.

### BRIEF DESCRIPTION OF THE DRAWINGS

FIG. 1 depicts an example system.

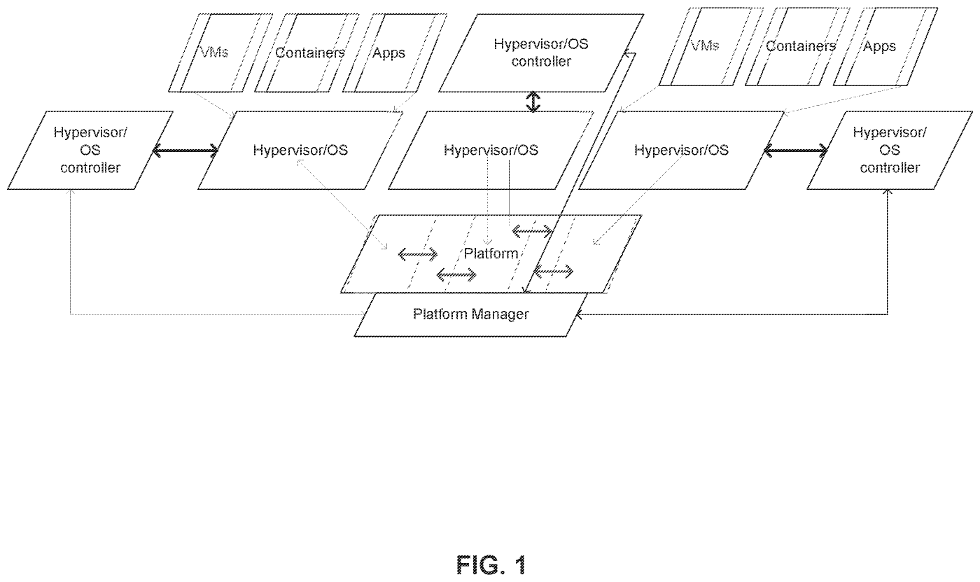

FIG. 2 depicts an example architecture of supporting multiple OS and hypervisor controllers.

FIG. 3 depicts an example system.

FIG. 4 depicts an example of resource mapping.

FIG. 5 depicts an example sequence of events.

FIG. 6 depicts an example process.

FIG. 7 depicts an example system.

### DETAILED DESCRIPTION

Some examples described herein provide coexistence of multiple hypervisors and operating systems executing in a platform while being independently controlled by controllers, for example, without an additional layer of virtualization (e.g., bare metal) on the platform. Some examples described herein provide technologies to provide dynamic hardware assignments to multiple tenants such as virtual machines, container, and applications through negotiation, such as on an as requested basis. Technologies permit multiple resource orchestrators to simultaneously execute multiple OSs and hypervisors and provide dynamic reconfiguration of hardware resources. Heterogeneous applications such as the hybrid-cloud and edge can utilize multiple controllers to allocate hardware resources. Examples described herein allow shared utilization of hardware on a bare metal system that can run multiple OSs for multiple tenants on a platform with support by multiple OS controllers. In some examples, the hardware platform need not be partitioned to execute multiple hypervisors and operating systems.

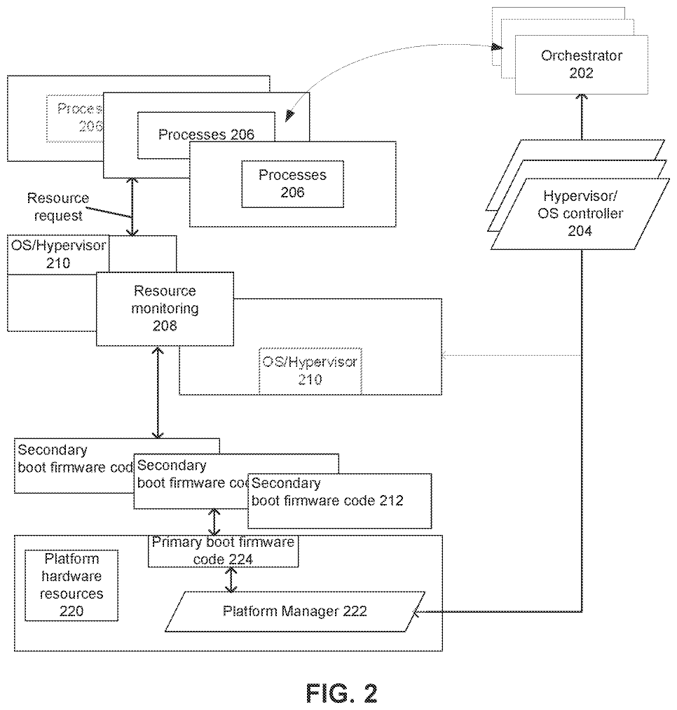

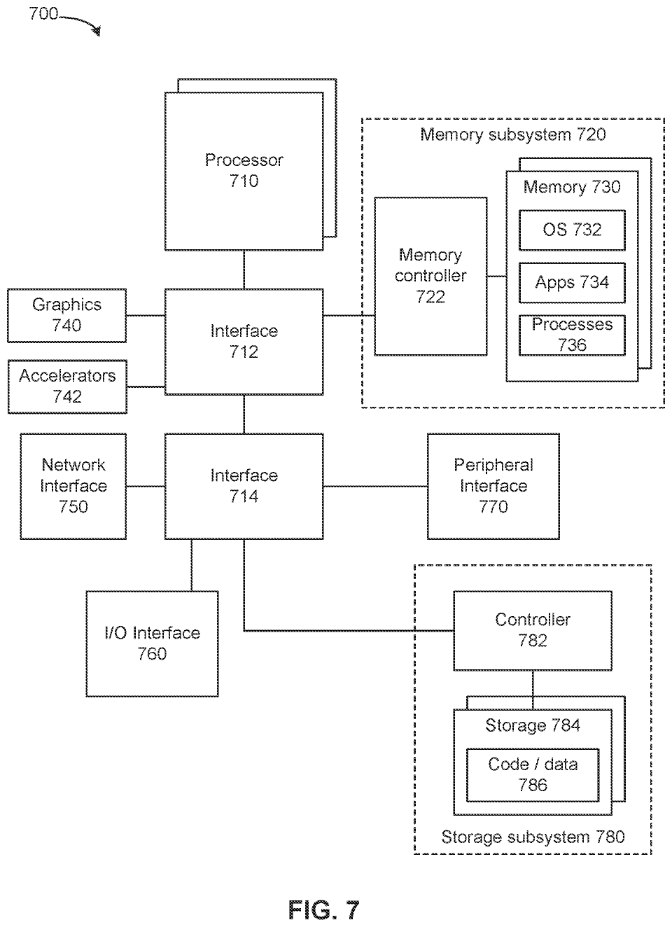

FIG. 2 depicts an example architecture that is to execute multiple OS and hypervisors. Orchestrator 202 can cause execution of processes 206 on one or more platforms to utilize platform hardware resources 220. Examples of orchestrator 202 can include Amazon Lambda, Microsoft Azure function, Google CloudRun, Knative, Azure, or others. Various examples of platforms are described at least with respect to FIG. 7.

Platform hardware resources 220 can include one or more of: one or more of: one or more processors; one or more programmable packet processing pipelines; one or more accelerators; one or more hardware queue managers (HQM), one or more application specific integrated circuits (ASICs); one or more field programmable gate arrays (FPGAs); one or more graphics processing units (GPUs); one or more memory devices; one or more storage devices; one or more interconnects; one or more network interface devices; one or more servers; one or more computing platforms; a composite server formed from devices connected by a network, fabric, or interconnect; one or more accelerator devices; or others. In some examples, a network interface device can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Based on hardware requirements changing to meet quality of service (QoS) demands, processes 206 (e.g., VMs, applications, or containers) managed by a hypervisor and utilizing an OS can request hardware resources from orchestrator 202 via an application program interface (API), command line interface, configuration file, or others. For example, orchestrator 202 could coordinate with other orchestrators and/or hypervisor/operating system (HV/OS) controllers 204 to negotiate for resource allocation, and make a request for hardware resources to platform manager 222.

In some examples, processes 206 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure.

Resource monitor 208 can include circuitry to monitor resource utilization of platform hardware resources 220 and indicate available resources to hypervisor/OS controllers 204. Resource monitor 208 can be implemented as Intel® Resource Director Technology (RDT), or other circuity, in some examples. For example, tracked resources can include one or more of: allocated amount of memory, allocated memory bandwidth, allocated amount of storage, allocated network interface bandwidth, frequency of operation of a central processing unit (CPU), number of allocated CPU cores, type and number of allocated accelerators, or others.

One or more OS and hypervisor controllers 204 can include circuitry to allocate one or more hardware resources of platform hardware resources 220 based on demands of processes 206 and available hardware resources. OS and hypervisor controller 204 can configure platform manager 222 to share the physical hardware resources. For example, platform manager 222 can be implemented as one or more of: a baseboard management controller (BMC); Dell's iDRAC; out-of-band management circuitry; circuitry consistent with Intelligent Platform Management Interface (IPMI) 2.0 standard (2004); circuitry that provides a browser-based, application program interface (API), command-line interface, or other interface for managing and monitoring utilization of hardware resources 220; or others. OS and hypervisor controllers 204 can communicate with an edge controller and an enterprise cloud controller to manage hardware resource allocation.

For example, orchestrators 202 can request hypervisor/OS controllers 204 to request resource allocation of platform hardware resources 220 to meet quality of service (QoS) or service level agreement (SLA) of one or more of processes 206. An SLA can specify at least one or more of: allocated memory bandwidth, allocated memory, allocated storage bandwidth, allocated storage, allocated network interface device bandwidth, allocated number of cores, processor utilization percentage, processor operating frequency, system uptime, or other criteria. Platform manager 222 can receive requests from hypervisor/OS controllers 204 to reconfigure platform resources for addition and deletion (e.g., removal) of allocated hardware resources subject to availability of hardware resources. One or more of hypervisor/OS controllers 204 can include circuitry to orchestrate execution of OS and hypervisor images 210 on a bare-metal platform in order to manage hardware resources without virtualization of hardware resources. Hypervisor/OS controllers 204 can be based on one or more of: OpenStack, Kubernetes (K8), vSphere, among others.

Platform manager 222 can include circuitry to manage platform hardware resources 220 via one or more boot firmware codes to interact with OS and hypervisor 210 in order to reconfigure and share the hardware resources with multiple tenants (such as the hypervisors, containers, and applications). For example, primary boot firmware code 224 can receive an allocation of platform hardware resources 220 on a bare metal system. A bare metal system can include a computing platform that executes instructions directly on hardware without an intervening operating system. Primary boot firmware code 224 can allocate resource allocations to one or more secondary boot firmware code 212. Secondary boot firmware code 212 can allocate one or more resources allocations to the multiple operating systems (OSs) and hypervisors 210.

In some examples, boot firmware code or firmware can include one or more of: Basic Input/Output System (BIOS), Universal Extensible Firmware Interface (UEFI), or a boot loader. The BIOS firmware can be pre-installed on a personal computer's system board or accessible through an Serial Peripheral Interface (SPI) interface from a boot storage (e.g., flash memory). In some examples, firmware can include Server Platform Services (SPS). In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

For example, platform manager 222 can request primary boot firmware code 224 to configure one or more secondary boot firmware codes 212 to extend or shrink allocated hardware resources based on hardware resource utilization to potentially improve hardware utilization efficiencies across multiple tenants (such as hypervisors, containers, and applications). While registering with platform manager 222, one or more of hypervisor/OS controllers 204 can request resources of platform hardware resources 220 based on initial need or configuration of one or more of processes 206. A platform can operate in power conserving mode by selectively turning off the hardware components that are not being assigned to an OS or hypervisor.

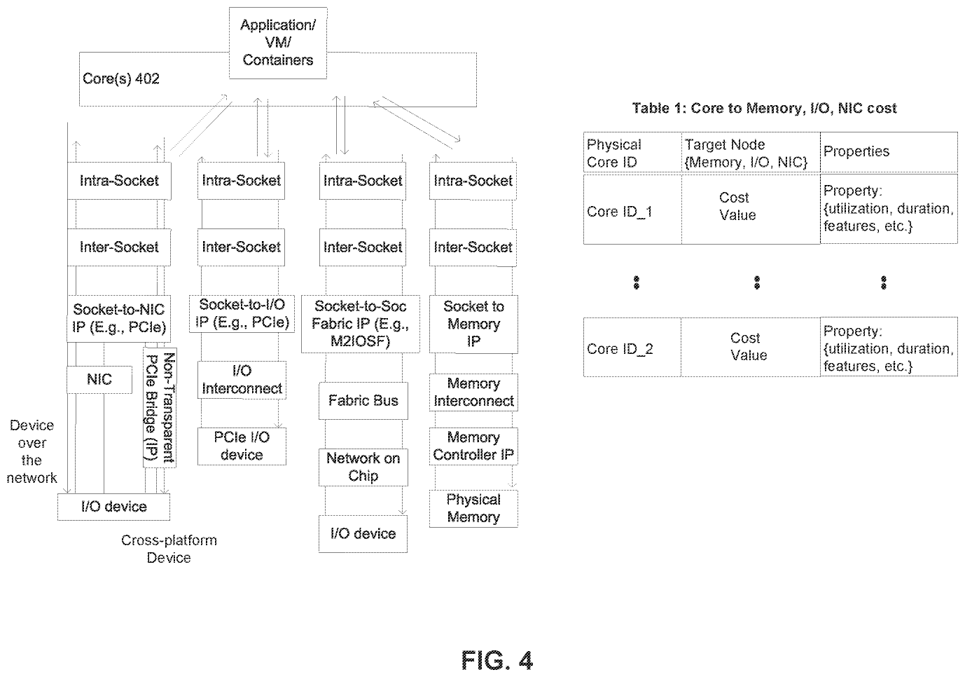

Platform manager 222 can create a metrics table of resources 220. For example, to create a metrics table of resources 220, platform manager 222 can evaluate distances and cost of association of one or more of resources 220 to OS/hypervisor 210 based on metrics. For example, FIG. 4 depicts an example of a metrics table in Table 1. For example, platform manager 222 can generate a metrics table by executing threads on CPU cores to estimate the transaction cost with other components from a core to memory components, input/output (I/O) devices, and network interface controller (NIC) ports to generate the relative cost metrics based on initial test transactions by the platform manager 222. Grouping of resources can occur by selecting components based on the cost for the association of resources for a given OS and hypervisor. Platform hardware resources 220 can be grouped to reduce an overall cost of component-to-component transactions during resource assignment to independent OS and hypervisor. Groupings can be based on locality or physical distance of memory, input/output (I/O), NIC, to the cores that execute a process, among processes 206, that is to utilize hardware resources 220. Groupings can represent latency of hardware accesses and utilization. Groupings can be ranked based on expected latency of hardware accesses and utilization.

OS and hypervisor 210, executed by one or more processors, can request dynamic hardware scaling up or down of resources 220 allocated to a process 206 and an OS and hypervisor 210. The system need not be reset to reconfigure the bare metal system to reallocate resources. Values written by communications from OS/hypervisor 210 to secondary boot firmware code 212 can write to registers (e.g., model specific registers (MSR)) to request change of core operations, change firmware (running on IO devices or accelerators), or request information. Communications from OS/hypervisor to secondary boot firmware code for memory layout mapping and resource sharing can be made based on Advanced Configuration and Power Interface (ACPI). For example, a ACPI request by the hypervisors, OS, or applications to the boot firmware code management entity or boot system (e.g., primary boot firmware code or secondary boot firmware code) can exclusively allocate one or more of hardware resources 220 to an OS 210 and associated processes 206.

Examples of OS 210 include Linux®, Windows® Server, VMware ESXi, and other operating systems. Multiple OS and hypervisors can provide dynamic resource allocation when executed in a bare-metal platform without virtualization.

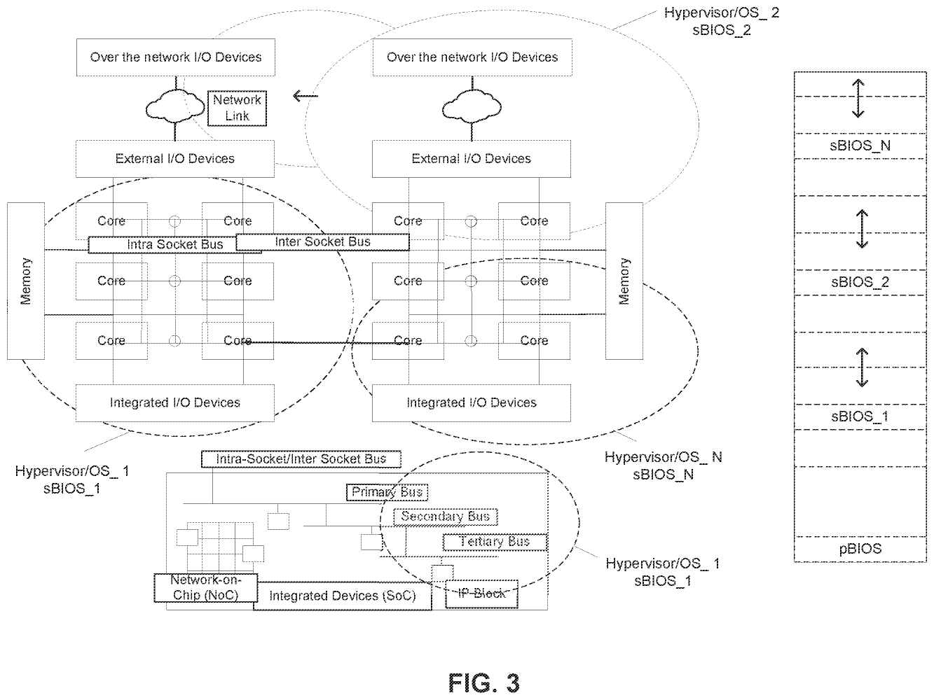

FIG. 3 depicts an example system. Primary boot firmware code or first boot system (e.g., pBIOS) can receive an allocation of memories, I/O, cores, devices, or other hardware resources. Allocation of hardware resources can be received through ACPI notifications. One or more secondary boot firmware code or second boot systems (e.g., sBIOS) can allocate resources allocated to the primary boot firmware code to different OSs and hypervisors. For example, primary boot firmware code can allocate resources for sharing to one or more different OSs and hypervisors by secondary boot firmware code (e.g., sBIOS_1, sBIOS_2, . . . sBIOS_N, where N is an integer of 3 or more).

FIG. 4 depicts an example of resource mapping. Table 1 can be computed to group hardware resources in a manner that reduces the overall transaction cost between the grouped resources. Transaction cost can represent latency of completion of operation on a core arising from use of a group of hardware resources. For example, a primary boot firmware code can execute probing code on cores to determine cost or latency of accessing various hardware resources.

The cost and properties can be provided to a platform manager circuitry (e.g., Dell iDRAC) which could be used in dynamic hardware allocation to provide locality of memory, I/O, network interface device, accelerators, and other devices, to the processes executed by cores. Platform manager circuitry can provide secure local and remote server management to help administrators deploy, update, and monitor server workloads.

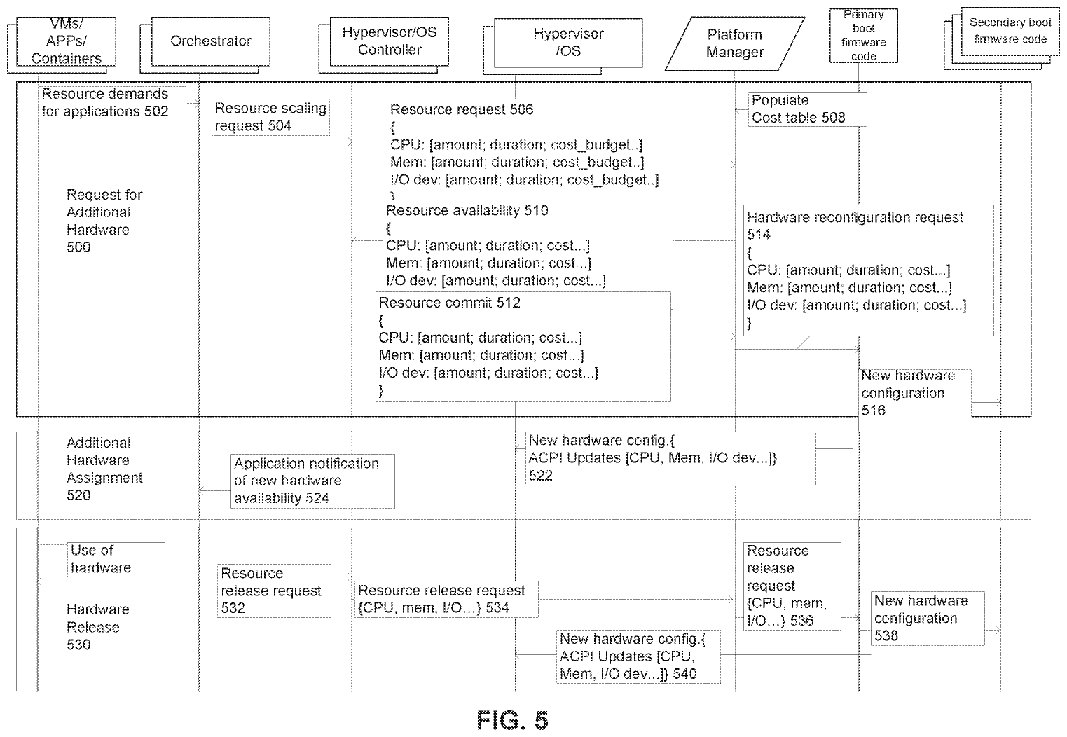

FIG. 5 depicts an example of operations. Various examples of signaling messages can provide dynamic hardware allocation, by controllers, to multiple hypervisors and operating systems by use of primary boot firmware code and secondary boot firmware code. During phase 500, at 502, one or more processes (e.g., applications, VMs, or containers) can request the resources from an orchestrator. At 504, orchestrator can identify to hypervisor/OS controller an opportunity for resource scaling in one or more platforms. At 506, OS/hypervisor controller can request the platform manager to make a request for additional hardware allocation for the processes, such as additional allocation of CPU, memory, accelerator, I/O, and other devices as well as corresponding amount of allocation, duration, cost_budget, and so forth.

In response to a request for additional resources, at 508, based on a cost table that groups resources according to physical proximity to a processor that executes the one or more processes, at 510, platform manager can identify available hardware components to a hypervisor/OS controller. For example, platform manager can identify available CPU, memory, accelerator, I/O, and other devices as well as corresponding amount of allocation, duration, cost_budget, and so forth.

At 512, an orchestrator can request a commitment of resources from platform manager. For example, orchestrator can request available CPU, memory, I/O, and other devices as well as corresponding amount of allocation, duration, cost_budget, and so forth. At 514, platform manager can request primary BIOS to allocate hardware resources specified in 512. At 516, primary BIOS can provide an updated hardware configuration to a secondary boot firmware code to configure hardware resources specified in 514 for the processes. For example, firmware and configuration updates can be made to the hardware components to configure the hardware for use by the one or more requester processes, and ACPI notifications can be sent to the operating systems and hypervisors about the new assignment of hardware.

At 520, additional hardware resources can be allocated to orchestrator. For example, at 522, secondary boot firmware code can allocate additional hardware resources for use by one or more processes to an associated hypervisor and/or OS. Allocation can be made using messages consistent with ACPI. At 524, the hypervisor and/or OS can indicate available hardware resources to the orchestrator.

At 530, the orchestrator can release hardware allocated to one or more processes for utilization by other processes. At 532, the orchestrator can issue a resource release request to hypervisor/OS controller. At 534, hypervisor/OS controller can specify resources to release to platform manager. At 536, platform manager can request primary boot firmware code to release resources specified in 534. At 538, primary boot firmware code can specify another hardware configuration to secondary boot firmware code to be allocated to the processes that formerly utilized the released hardware. At 540, the secondary boot firmware code can issue a revised hardware configuration to hypervisor / OS for allocation to the processes.

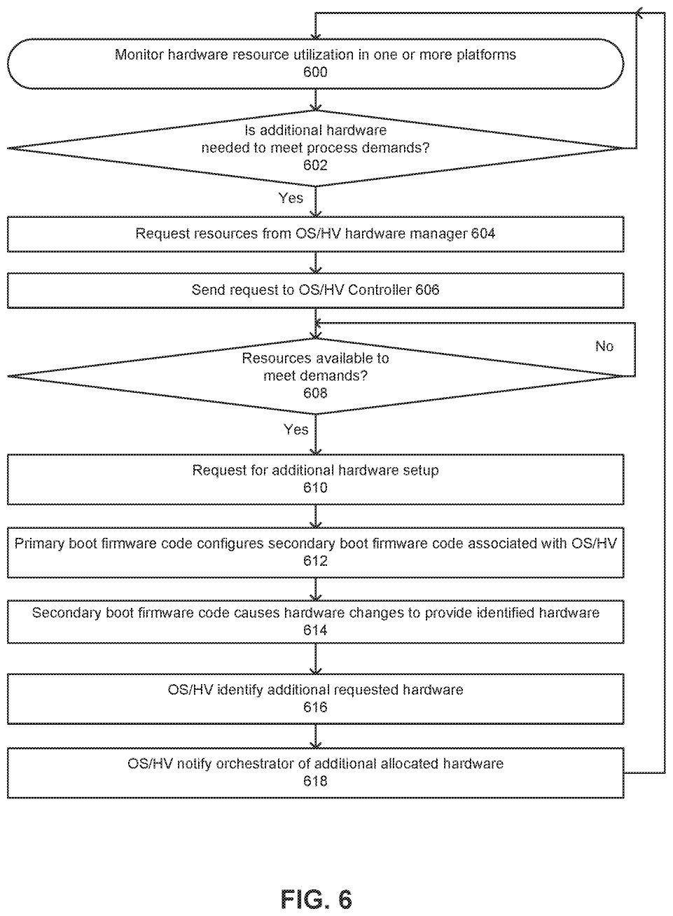

FIG. 6 depicts an example process. A first boot firmware code can allocate resources to one or more second boot firmware codes and the second boot firmware codes can allocate resources to one or more operating systems for utilization by one or more processes. Multiple hypervisors and operating systems can perform dynamic resource scaling. At 600, hardware resource utilization can be monitored in one or more platforms. For example, circuitry in one or more platforms can monitor allocated amount of memory, allocated memory bandwidth, allocated amount of storage, allocated network interface device bandwidth, frequency of operation of a CPU, number of allocated CPU cores, type and number of allocated accelerators, or other hardware characteristics.

At 602, a determination can be made if additional hardware resources are to be allocated to meet demands of executing processes. For example, demands of executing processes can be based on QoS or SLAs. Based on relevant QoS or SLAs not being met, additional hardware resources can be allocated to executed processes and 604 can follow. Based on relevant QoS or SLAs being met, the process can return to 600.

At 604, orchestrator can request hardware resources from an OS/HV controller. At 606, the OS/HV controller can issue a request for hardware resources to a platform manager. At 608, a determination can be made as to whether resources are available to meet the requests for hardware resources. For example, resources can be identified that meet demands, e.g., type (e.g., memory, CPU, etc.), duration, SLAs, and other factors. Based on resources being available to meet demands, the process can proceed to 610. Based on resources not being available to meet demands, the process can repeat 608 for a configured amount of time. After the configured amount of time, the process can return to 600 or issue an alert to a network administrator that resources are not available and the network administrator can potentially allocate additional resources.

At 610, the orchestrator can issue a request for additional hardware to platform manager to meet specified hardware demands. For example, the platform manager can select one or more hardware resources based on proximity to the processor that executes the one or more processes that are to utilize the demanded hardware.

At 612, the platform manager can cause the primary boot firmware code to configure a secondary boot firmware code associated with the OS and hypervisor, that manages the one or more processes that are to utilize the demanded hardware, to allocate the selected hardware resources to the one or more processes that are to utilize the demanded hardware. At 614, the secondary boot firmware code can allocate the identified hardware resources to the OS and hypervisor by configuration. For example, the secondary boot firmware code can issue firmware and configuration updates to the identified hardware components and send ACPI notifications to the operating system and hypervisor to indicate assignment of hardware.

At 616, operating system and hypervisor can identify additional allocated requested hardware. At 618, the operating system and hypervisor can notify the orchestrator of a newly allocated hardware.

FIG. 7 depicts an example computing system. Components of system 700 (e.g., processor 710, accelerators 742, network interface 750, memory 730, storage 784, and so forth) can be configured to execute a primary and/or secondary boot firmware codes to allocate resources to an OS and hypervisor, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Network interface 750 can include one or more of: a network interface controller (NIC), a remote direct memory access (RDMA)-enabled NIC, SmartNIC, router, switch, or network-attached appliance. Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU.

For example, network interface 750 can include Media Access Control (MAC) circuitry, a reconciliation sublayer circuitry, and physical layer interface (PHY) circuitry. The PHY circuitry can include a physical medium attachment (PMA) sublayer circuitry, Physical Medium Dependent (PMD) circuitry, a forward error correction (FEC) circuitry, and a physical coding sublayer (PCS) circuitry. In some examples, the PHY can provide an interface that includes or use a serializer de-serializer (SerDes). In some examples, at least where network interface 750 is a router or switch, the router or switch can include interface circuitry that includes a SerDes.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. A volatile memory is memory whose state (and therefore the data stored in it) is indeterminate if power is interrupted to the device. A non-volatile memory (NVM) device is a memory whose state is determinate even if power is interrupted to the device. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) (e.g., NVMe-oF specification, version 1.0 (2016) as well as variations, extensions, and derivatives thereof) or NVMe (e.g., Non-Volatile Memory Express (NVMe) Specification, revision 1.3c, published on May 24, 2018 (“NVMe specification”) as well as variations, extensions, and derivatives thereof).

Communications between devices can take place using a network that provides die-to-die communications; chip-to-chip communications; circuit board-to-circuit board communications; and/or package-to-package communications.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

What is claimed is:

1. A non-transitory computer-readable medium comprising instructions stored thereon, that if executed by one or more processors, cause the one or more processors to:
execute a first boot firmware code to receive an allocation of hardware devices and
allocate, by the first boot firmware code, resource allocations to one or more secondary boot firmware codes.

2. The computer-readable medium of claim 1, comprising instructions stored thereon, that if executed by one or more processors, cause the one or more processors to:
allocate, by the one or more secondary boot firmware codes, use of hardware devices to one or more operating systems (OSs).

3. The computer-readable medium of claim 2, wherein the one or more secondary boot firmware codes allocate use of hardware devices to one or more OSs via one or more Advanced Configuration and Power Interface (ACPI) notifications.

4. The computer-readable medium of claim 1, wherein the hardware devices comprise one or more of: memory, general purpose processor, graphics processing unit (GPU), an accelerator, or a network interface device.

5. The computer-readable medium of claim 2, wherein the one or more OSs are to execute on a bare metal system.

6. The computer-readable medium of claim 2, wherein two or more OSs and hypervisors are to execute on a bare metal system without hardware partitioning.

7. The computer-readable medium of claim 1, wherein one or more hypervisor and operating system (OS) controllers are to request an allocation of hardware devices for one or more processes and wherein the first boot firmware code is to receive an allocation of hardware devices based on the request from the one or more hypervisor and OS controllers.

8. An apparatus comprising:
a memory and
at least one processor, that based on execution of instructions stored in the memory, is to:
execute a first boot firmware code to receive an allocation of hardware devices and
allocate, by the first boot firmware code, resource allocations to one or more secondary boot firmware codes.

9. The apparatus of claim 8, wherein the at least one processor, based on execution of instructions stored in the memory, is to allocate, by the one or more secondary boot firmware codes, use of hardware devices to one or more operating systems (OSs) and wherein the one or more secondary boot firmware codes allocate use of hardware devices to one or more OSs via one or more Advanced Configuration and Power Interface (ACPI) notifications.

10. The apparatus of claim 8, wherein the hardware devices comprise one or more of: memory, general purpose processor, graphics processing unit (GPU), an accelerator, or a network interface device.

11. The apparatus of claim 8, comprising the hardware devices communicatively coupled to the at least one processor and wherein the hardware devices comprise one or more of: memory, general purpose processor, graphics processing unit (GPU), an accelerator, or a network interface device.

12. The apparatus of claim 9, wherein the one or more OSs are to execute on a bare metal system.

13. The apparatus of claim 8, wherein two or more operating systems (OSs) and hypervisors are to execute on a bare metal system without hardware partitioning.

14. The apparatus of claim 8, wherein one or more hypervisor and operating system (OS) controllers are to request an allocation of hardware devices for one or more processes and wherein the first boot firmware code is to receive an allocation of hardware devices based on the request from the one or more hypervisor and OS controllers.

15. A method comprising:
executing a first boot system to receive an allocation of hardware devices;
allocating, by the first, resource allocations to one or more secondary boot systems; and
allocating, by the one or more secondary boot systems, use of hardware devices to one or more operating systems (OSs), wherein the first boot system comprises one of: a basic input/output systems (BIOS), Universal Extensible Firmware Interface (UEFI), or a boot loader and wherein the one or more secondary boot systems comprises one or more of: a BIOS, UEFI, or a boot loader.

16. The method of claim 15, wherein the one or more secondary boot systems allocate use of hardware devices to one or more OSs via one or more Advanced Configuration and Power Interface (ACPI) notifications.

17. The method of claim 15, wherein the hardware devices comprise one or more of: memory, general purpose processor, graphics processing unit (GPU), an accelerator, or a network interface device.

18. The method of claim 15, wherein the one or more OSs are to execute on a bare metal system.

19. The method of claim 15, wherein two or more OSs and hypervisors are to execute on a bare metal system without hardware partitioning.

20. The method of claim 15, wherein one or more hypervisor and OS controllers are to request an allocation of hardware devices for one or more processes and wherein the first boot system is to receive an allocation of hardware devices based on the request from the one or more hypervisor and OS controllers.
